(19) United States
(12) Patent Application Publication
(10) Pub. No.: US 2026/0153410 A1
(43) Pub. Date: Jun. 4, 2026

(54) LOAD ABSORPTION APPARATUS AND METHOD FOR GAS TURBINE TESTING

(71) Applicant: DOOSAN ENERBILITY CO., LTD., Changwon (KR)

(72) Inventors: Jae Hoon CHUNG, Changwon (KR); In Hyung PARK, Seoul (KR); Sung Ryong LEE, Daegu (KR); Young Jin JUNG, Seongnam (KR)

(21) Appl. No.: 19/394,528

(22) Filed: Nov. 19, 2025

(30) Foreign Application Priority Data
Nov. 29, 2024 (KR) 10-2024-0174561

(51) Int. Cl. G01M 15/14; F02C 7/36

(52) U.S. Cl. CPC G01M 15/14; F02C 7/36

(57) ABSTRACT

A load absorption apparatus and method for gas turbine testing is provided. The load absorption apparatus may include a load compressor placed in front of a gas turbine, and having a plurality of compressor modules arranged in sections according to a capacity of the gas turbine, and a drive module configured to provide power to the load compressor.

### CROSS REFERENCE TO RELATED APPLICATION

This application claims priority to Korean Patent Application No. 10-2024-0174561, filed on November 29, 2024, the disclosure of which is incorporated herein by this reference in its entirety.

### BACKGROUND

### TECHNICAL FIELD

Apparatuses and methods consistent with exemplary embodiments relate to a load absorption apparatus and method for gas turbine testing and, more particularly, to a load absorption apparatus and method for enabling testing of gas turbines of various capacities.

### DESCRIPTION OF THE RELATED ART

A gas turbine is a power engine that mixes air compressed by a compressor with fuel for combustion and rotates a turbine with hot gas produced by the combustion. The gas turbine is used to drive a generator, an aircraft, a ship, a train, or the like.

The gas turbine includes a compressor, a combustor, and a turbine. The compressor draws in and compresses air, and transmits the compressed air to the combustor.

The combustor mixes the compressed air which has a high- pressure and high-temperature and is supplied from the compressor with fuel and combusts a mixture to produce combustion gas which is discharged to the turbine.

The turbine blades in the turbine are rotated by the combustion gas to generate power. The generated power is used in various fields, such as power generation and operating mechanical devices.

Gas turbines are engineered to meet defined design specifications. The gas turbine development process involves an iterative cycle of testing, improving and retesting to ensure that performance goals are achieved in accordance with the original design requirements.

Certain compressor models are used as load absorption devices for gas turbine testing. However, using a compressor that reflects the actual size and overall stage as a load absorption device can limit testing to a specific capacity range, making it difficult to test gas turbines of various capacities.

In other words, a single load compressor model is insufficient to test gas turbines of various unit sizes from small to large, so it is necessary to manufacture and operate a separate load compressor suitable for the capacity of the gas turbine being tested.

### SUMMARY

Aspects of one or more exemplary embodiments provide a load absorption apparatus and method for enabling testing of gas turbines of various capacities.

Additional aspects will be set forth in part in the description which follows and, in part, will become apparent from the description, or may be learned by practice of the exemplary embodiments.

According to an aspect of an exemplary embodiment, there is provided a load absorption apparatus including: a load compressor placed in front of a gas turbine and having a plurality of compressor modules arranged in sections according to a capacity of the gas turbine; and a drive module configured to provide power to the load compressor.

The load compressor may be an axial-type multi-stage compressor, and the compressor module may be sequentially divided according to the capacity of the gas turbine.

The load absorption apparatus may further include a controller configured to selectively drive the load compressor or the drive module based on a preset capacity of the gas turbine.

The load compressor may include: a casing in which an inlet is formed at a front end to allow air to flow in and the compressor modules are sequentially arranged inside; a chamber installed at a rear end of the casing and configured to communicate with the casing; a plurality of exhaust lines installed in the casing and the chamber; and a plurality of valves installed on each exhaust line to open and close the exhaust line.

The compressor modules divided according to the capacity of the gas turbine along an air flow direction from the front end of the casing may include a low pressure section, a medium-low pressure section, a medium-high pressure section, and a high pressure section,

The low pressure section may be positioned at the front end of the casing and may be configured to communicate with the inlet of the casing, the medium-low pressure section may be positioned at a rear end of the low pressure section and may be configured to communicate with the low pressure section, the medium-high pressure section may be positioned at a rear end of the medium-low pressure section and may be configured to communicate with the medium-low pressure section, and the high pressure section may be positioned at a rear end of the medium-high pressure section and may be configured to communicate with the medium-high pressure section.

The plurality of exhaust lines may include: a low pressure section exhaust line positioned between the low pressure section and the medium-low pressure section and configured to communicate with the casing; a medium-low pressure section exhaust line positioned between the medium-low pressure section and the medium-high pressure section and configured to communicate with the casing; a medium-high pressure section exhaust line positioned between the medium-high pressure section and the high pressure section and configured to communicate with the casing; and a high pressure section exhaust line configured to communicate with the chamber.

The valve may be a discharge valve configured to be controlled remotely.

The plurality of valves may include: a low pressure section valve installed in the low pressure section exhaust line to open and close the low pressure section exhaust line; a medium-low pressure section valve installed in the medium-low pressure section exhaust line to open and close the medium-low pressure section exhaust line; a medium-high pressure section valve installed in the medium-high pressure section exhaust line to open and close the medium-high pressure section exhaust line; and a high pressure section valve installed in the high pressure section exhaust line to open and close the high pressure section exhaust line.

The chamber and the valves may be configured to control back pressure and load.

The drive module may include: a motor; a rotary shaft installed on the motor and configured to rotate; and a clutch including a plurality of clutches and installed between the rotary shaft and the compressor modules, the clutches being spaced apart from each other along a length direction of the rotary shaft to selectively transmit power of the motor to the compressor modules.

The clutches may include: a first clutch installed on the rotary shaft and positioned between the low pressure section and the medium-low pressure section; a second clutch installed on the rotary shaft and positioned between the medium-low pressure section and the medium-high pressure section; and a third clutch installed on the rotary shaft and positioned between the medium-high pressure section and the high pressure section.

According to an aspect of another exemplary embodiment, there is provided a load absorption method for gas turbine testing using a load absorption apparatus, the method including: selecting a compressor module according to a capacity of the gas turbine; and transmitting power to the compressor module.

In the selecting of compressor module, the capacity of the gas turbine to be tested may be preset in the controller, and the compressor module corresponding to the capacity of the gas turbine may be selected from among a plurality of compressor modules based on the preset gas turbine capacity.

In the transmitting of power, when the low pressure section is selected, the first clutch may be disengaged to transmit the power of the motor to the low pressure section of the compressor modules to drive the low pressure section.

When the low pressure section is selected, the low pressure section valve may be open and the other valves may be closed, so that air flowing in through the inlet of the casing may pass through the low pressure section and be discharged to the low pressure section exhaust line.

In the transmitting of power, when the medium-low pressure section is selected, the first clutch may be engaged and the second clutch may be disengaged to transmit the power of the motor to the low pressure section and the medium-low pressure section of the compressor modules, thereby driving the low pressure section and the medium-low pressure section.

In the transmitting of power, when the medium-high pressure section is selected, the first clutch and the second clutch may be engaged and the third clutch may be disengaged to transmit the power of the motor to the low pressure section, the medium-low pressure section, and the medium-high pressure section of the compressor modules, so that the low pressure section, the medium-low pressure section, and the medium-high pressure section may be driven.

In the transmitting of power, when the high pressure section is selected, the first clutch, the second clutch, and the third clutch may be engaged to transmit the power of the motor to the low pressure section, the medium-low pressure section, the medium-high pressure section, and the high pressure section of the compressor modules, so that the entire plurality of compressor modules may be driven.

When the high pressure section is selected, the high pressure section valve may be open and the other valves may be closed, so that air flowing in through the inlet of the casing may pass through the low pressure section, the medium-low pressure section, the medium-high pressure section, the high pressure section, and the chamber, and be discharged to the high pressure section exhaust line.

According to one or more exemplary embodiments, the load compressor is configured such that the compressor module is divided according to the capacity of a gas turbine, and the power of the motor can be selectively transmitted to the compressor module through the clutch of the drive module.

Therefore, a single load compressor can be used to load gas turbines of various capacities, eliminating the need to manufacture dedicated load compressors or modify equipment for each gas turbine, reducing costs and shortening testing schedules.

### BRIEF DESCRIPTION OF THE DRAWINGS

The above and other aspects, features, and advantages of certain embodiments of the present disclosure will be more clearly understood from the following detailed description taken in conjunction with the accompanying drawings, in which:

FIG. 1 is a configuration view of a load absorption apparatus for gas turbine testing according to an exemplary embodiment;

FIG. 2 is an enlarged view of a load compressor and a drive module shown in FIG. 1;

FIG. 3 is a flowchart showing a load absorption method for gas turbine testing according to an exemplary embodiment;

FIG. 4 shows the driving state of a low pressure section shown in FIG. 2;

FIG. 5 shows the driving state of a medium-low pressure section shown in FIG. 2;

FIG. 6 shows the driving state of a medium-high pressure section shown in FIG. 2; and

FIG. 7 shows the driving state of a high pressure section shown in FIG. 2.

### DETAILED DESCRIPTION

Various modifications and various embodiments will be described below in detail with reference to the accompanying drawings so that those skilled in the art can easily carry out the disclosure. It should be understood, however, that the various embodiments are not for limiting the scope of the disclosure to the specific embodiments, but they should be interpreted to include all modifications, equivalents, and alternatives of the embodiments included within the spirit and scope disclosed herein.

The terms used herein are for the purpose of describing specific embodiments only and are not intended to limit the scope of the disclosure. As used herein, the singular expressions include plural expressions as well, unless the context clearly indicates otherwise. In the disclosure, terms such as “comprise,” “include” and “have/has” should be construed as designating the presence of such features, numbers, steps, operations, components, parts, and/or combinations thereof, and do not exclude the possibility of addition or presence of one or more other features or numbers, steps, operations, components, parts, and/or combinations thereof.

Hereinafter, exemplary embodiments will be described in detail with reference to the attached drawings. It should be noted that, where possible, identical components are represented by identical symbols in the attached drawings. In certain embodiments, detailed descriptions of known functions and configurations that may obscure the gist of the present disclosure will be omitted. For the same reason, some components in the attached drawings may be exaggerated, omitted, or schematically depicted.

Below, a load absorption apparatus for gas turbine testing according to an exemplary embodiment is described.

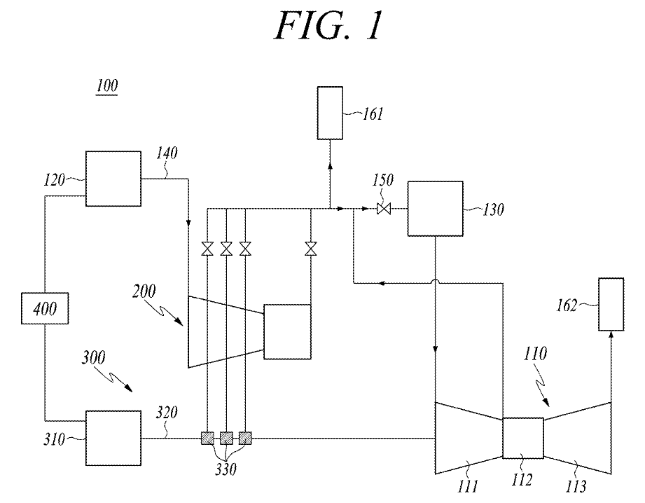

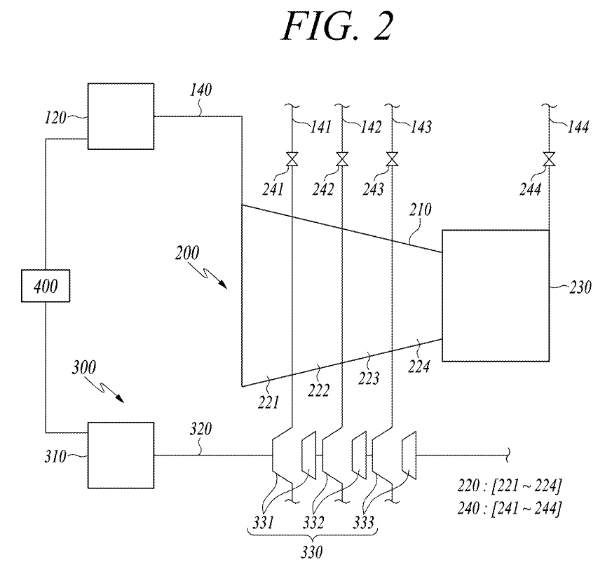

FIG. 1 is a configuration view of a load absorption apparatus for gas turbine testing according to an exemplary embodiment. FIG. 2 is an enlarged view of a load compressor and a drive module shown in FIG. 1.

Referring to FIGS. 1 and 2, a load absorption apparatus 100 for gas turbine testing may include a gas turbine 110, inlet modules 120 and 130, a load compressor 200, a drive module 300, and a controller 400.

The gas turbine 110, the inlet modules 120 and 130, the load compressor 200 are interconnected via an air flow line 140, and the inlet modules 120 and 130 may be placed in front of the load compressor 200 and in front of the gas turbine 110, respectively.

The inlet modules 120 and 130 may filter air drawn into the inlet modules 120 and 130, control the flow rate and pressure of the air, and then supply air to the load compressor 200 and the gas turbine 110 through the air flow line 140.

A plurality of inlet guide vanes (IGV) are arranged at an entrance of the inlet modules 120 and 130, and the flow rate and flow angle of air flowing into the inlet modules 120 and 130 can be controlled by adjusting the angle of the inlet guide vane.

The load compressor 200 may be, e.g., an axial-type multi-stage compressor. The load compressor 200 is arranged in front of the gas turbine 110, and a plurality of compressor modules 220 may be arranged in sections according to the capacity of the gas turbine 110.

The load compressor 200 may include a casing 210, a chamber 230, exhaust lines 141 to 144, and a plurality of valves 240.

The casing 210 constitutes the exterior of the load compressor 200. An inlet is formed at the front end of the casing 210 to allow air to flow in, and disks, blades, vanes, and the like constituting the compressor module 220 may be accommodated in the casing 210.

The compressor module 220 may be sequentially divided according to the capacity of the gas turbine 110 along the air flow direction from the front end of the casing 210 and placed inside the casing 210.

The compressor module 220 may be divided into a low pressure section 221, a medium-low pressure section 222, a medium-high pressure section 223, and a high pressure section 224 according to the capacity of the gas turbine 110.

The low pressure section 221 may be arranged at the front end of the casing 210 and communicate with the inlet of the casing 210, and the medium-low pressure section 222 may be arranged at the rear end of the low pressure section 221 and communicate with the low pressure section 221.

The medium-high pressure section 223 may be arranged at the rear end of the medium-low pressure section 222 and communicate with the medium-low pressure section 222, and the high pressure section 224 may be arranged at the rear end of the medium-high pressure section 223 and communicate with the medium-high pressure section 223.

The chamber 230 and the valve 240 are configured to control back pressure and load. The chamber 230 is placed at the rear end of the casing 210 and communicates with the high pressure section 224. A plurality of exhaust lines 141 to 144 and a plurality of valves 240 may be installed in the casing 210 and the chamber 230.

The exhaust lines 141 to 144 may include a low pressure section exhaust line 141, a medium-low pressure section exhaust line 142, a medium-high pressure section exhaust line 143, and a high pressure section exhaust line 144.

The low pressure section exhaust line 141 is arranged between the low pressure section 221 and the medium-low pressure section 222 and communicates with the casing 210. When the low pressure section 221 of the compressor module 220 is driven, air introduced through the inlet of the casing 210 may pass through the low pressure section 221 and be discharged to the low pressure section exhaust line 141.

The medium-low pressure section exhaust line 142 is arranged between the medium-low pressure section 222 and the medium-high pressure section 223 and communicates with the casing 210. When the low pressure section 221 and the medium-low pressure section 222 of the compressor module 220 are driven, air introduced through the inlet of the casing 210 may pass through the low pressure section 221 and the medium-low pressure section 222 and be discharged to the medium-low pressure section exhaust line 142.

The medium-high pressure section exhaust line 143 is arranged between the medium-high pressure section 223 and the high pressure section 224 and communicates with the casing 210. When the low pressure section 221, the medium-low pressure section 222, and the medium-high pressure section 223 of the compressor module 220 are driven, air introduced through the inlet of the casing 210 may pass through the low pressure section 221, the medium-low pressure section 222, and the medium-high pressure section 223 and be discharged to the medium-high pressure section exhaust line 143.

The high pressure section exhaust line 144 communicates with the chamber 230, and when the low pressure section 221, the medium-low pressure section 222, the medium-high pressure section 223, and the high pressure section 224 of the compressor module 220 are driven, that is, when the entire compressor module 220 is operated, air introduced through the inlet of the casing 210 may pass through the low pressure section 221, the medium-low pressure section 222, the medium-high pressure section 223, the high pressure section 224, and the chamber 230 and be discharged to the high pressure section exhaust line 144.

The exhaust lines 141 to 144 are connected to the air flow line 140, and a portion of the air discharged from the exhaust lines 141 to 144 is supplied to the inlet module 130 (see FIG. 1) placed in front of the gas turbine 110, and the remainder may be discharged to an exhaust stack 161 (see FIG. 1).

The valve 240 is, e.g., a discharge valve that can be controlled remotely, and a plurality of valves 240 are provided in each of the exhaust lines 141 to 144 to open and close the exhaust lines 141 to 144.

The valve 240 may include a low pressure section valve 241, a medium-low pressure section valve 242, a medium-high pressure section valve 243, and a high pressure section valve 244.

The low pressure section valve 241 is installed in the low pressure section exhaust line 141 to open and close the low pressure section exhaust line 141, and the medium-low pressure section valve 242 may open and close the medium-low pressure section exhaust line 142.

The medium-high pressure section valve 243 is installed in the medium-high pressure section exhaust line 143 to open and close the medium-high pressure section exhaust line 143, and the high pressure section valve 244 is installed in the high pressure section exhaust line 144 to open and close the high pressure section exhaust line 144.

The drive module 300 may supply power to the gas turbine 110 (see FIG. 1) or the load compressor 200.

The drive module 300 may be configured to drive the stationary gas turbine 110 or the load compressor 200, and may control the power transmitted to the gas turbine 110 or the load compressor 200.

The drive module 300 may include a motor 310, a rotary shaft 320, and a clutch 330.

For example, an electric motor may be used as the motor 310. The rotary shaft 320 is installed on the motor 310 and may be rotated by driving the motor 310.

The clutch 330 comprises a plurality of clutches, and is installed between the rotary shaft 320 and the compressor module 220, spaced apart from each other along the length direction of the rotary shaft 320, to selectively transmit the power of the motor 310 to the compressor module 220.

The clutch 330 may include a first clutch 331, a second clutch 332, and a third clutch 333.

The first clutch 331 is installed on the rotary shaft 320 and is arranged between the low pressure section 221 and the medium-low pressure section 222. When the first clutch 331 is disengaged, the power of the motor 310 is transmitted to the low pressure section 221 of the compressor module 220, so that the low pressure section 221 may be driven.

The second clutch 332 is installed on the rotary shaft 320 and is arranged between the medium-low pressure section 222 and the medium-high pressure section 223. When the first clutch 331 is engaged and the second clutch 332 is disengaged, the power of the motor 310 is transmitted to the low pressure section 221 and the medium-low pressure section 222 of the compressor module 220, so that the low pressure section 221 and the medium-low pressure section 222 may be driven.

The third clutch 333 is installed on the rotary shaft 320 and is arranged between the medium-high pressure section 223 and the high pressure section 224. When the first clutch 331 and the second clutch 332 are both engaged and the third clutch 333 is disengaged, the power of the motor 310 is transmitted to the low pressure section 221, the medium-low pressure section 222, and the medium-high pressure section 223 of the compressor module 220, so that the low pressure section 221, the medium-low pressure section 222, and the medium-high pressure section 223 may be driven.

In addition, when the first, second, third clutches 331, 332, 333 are all engaged, the power of the motor 310 can be transmitted to the low pressure section 221, the medium-low pressure section 222, the medium-high pressure section 223, and the high pressure section 224 of the compressor module 220, that is, the entire compressor module 220, thereby driving the entire compressor module 220.

The gas turbine 110 (see FIG. 1) may include a compressor 111, a combustor 112, and a turbine 113.

The gas turbine 110 receives air from the inlet module 130 and combusts the air compressed by the compressor 111 to rotate the turbine 113. A portion of the air discharged from the gas turbine 110 may be supplied back to the inlet module 130 located in front of the gas turbine 110, and the remainder may be discharged to an exhaust stack 162.

The controller 400 may selectively control the operation of components constituting the load absorption apparatus 100 for gas turbine testing.

The controller 400 may selectively operate the load compressor 200 or the drive module 300 according to a preset capacity of the gas turbine 110.

Hereinafter, a load absorption method for gas turbine testing according to an exemplary embodiment will be described.

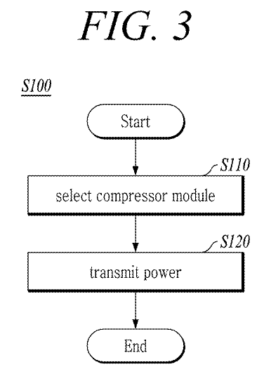

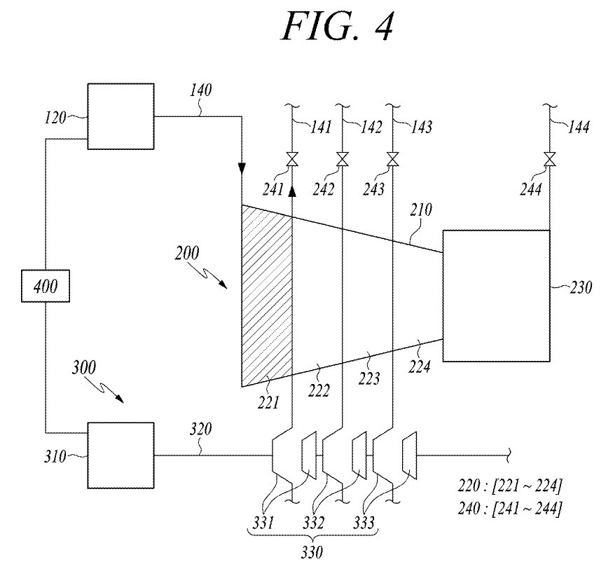

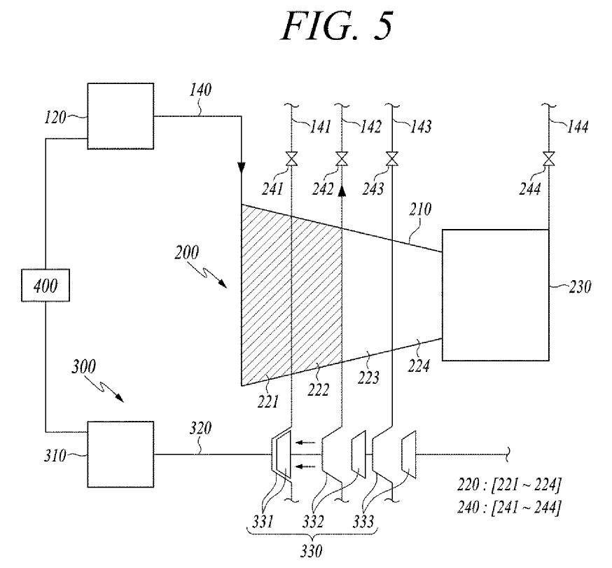

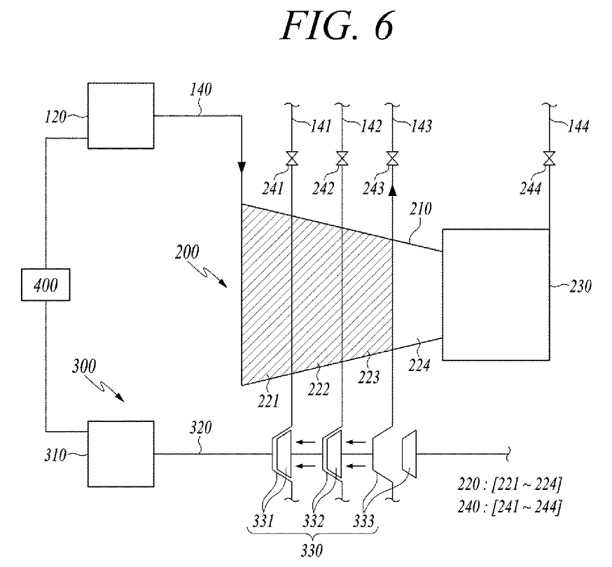

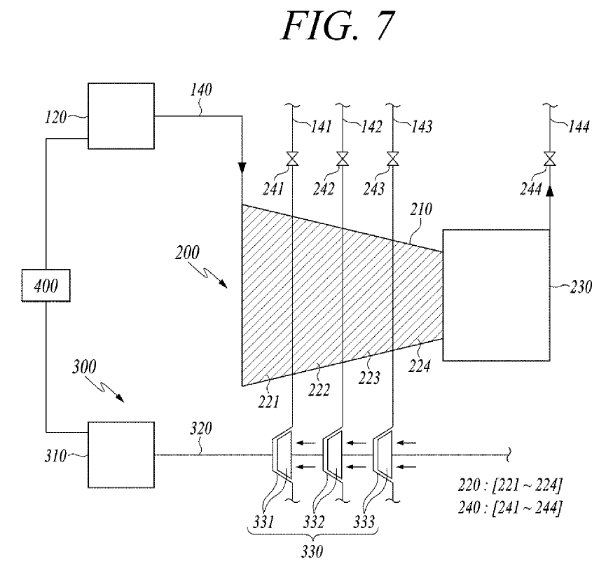

FIG. 3 is a flowchart showing a load absorption method for gas turbine testing according to an exemplary embodiment, FIG. 4 shows the driving state of a low pressure section shown in FIG. 2, FIG. 5 shows the driving state of a medium-low pressure section shown in FIG. 2, FIG. 6 shows the driving state of a medium-high pressure section shown in FIG. 2, and FIG. 7 shows the driving state of a high pressure section shown in FIG. 2.

Referring to FIGS. 3 to 7, a load absorption method S100 for gas turbine testing may include selecting a compressor module (operation S110) and transmitting power (operation S120).

In the step of selecting a compressor module (operation S110), the compressor module 220 is selected according to the capacity of the gas turbine 110 (see FIG. 1).

Specifically, an operator may preset the capacity of the gas turbine 110 to perform the test in the controller, and the controller 400 selects the compressor module 220 corresponding to the capacity of the gas turbine 110 from among a plurality of compressor modules based on the preset capacity of the gas turbine 110.

Thereafter, in the step of transmitting power (operation S120), power is transmitted to the selected compressor module 220.

For example, when the low pressure section 221 is selected, the controller 400 disengages the first clutch 331 to transmit the power of the motor 310 to the low pressure section 221 of the compressor module 220 to drive the low pressure section 221, opens the low pressure section valve 241, and closes the remaining valves 242, 243 and 244 so that air flowing in through the inlet of the casing 210 passes through the low pressure section 221 and is discharged to the low pressure section exhaust line 141 (see FIG. 4).

Alternatively, when the medium-low pressure section 222 is selected, the controller 400 engages the first clutch 331 and disengages the second clutch 332 to transmit the power of the motor 310 to the low pressure section 221 and the medium-low pressure section 222 of the compressor module 220, thereby driving the low pressure section 221 and the medium-low pressure section 222.

Further, the controller 400 opens the medium-low pressure section valve 242 and closes the remaining valves 240 so that air flowing in through the inlet of the casing 210 passes through the low pressure section 221 and medium-low pressure section 222 and is discharged to the medium-low pressure section exhaust line 142 (see FIG. 5).

Alternatively, when the medium-high pressure section 223 is selected, the controller 400 engages the first clutch 331 and the second clutch 332 and disengages the third clutch 333 to transmit the power of the motor 310 to the low pressure section 221, the medium-low pressure section 222, and the medium-high pressure section 223 of the compressor module 220 so that the low pressure section 221, the medium-low pressure section 222, and the medium-high pressure section 223 may be driven.

In addition, the controller 400 opens the medium-high pressure section valve 243 and closes the remaining valves 240 so that air flowing in through the inlet of the casing 210 passes through the low pressure section 221, medium-low pressure section 222, and the medium-high pressure section 223 and is discharged to the medium-high pressure section exhaust line 143 (see FIG. 6).

Alternatively, when the high pressure section 224 is selected, the controller 400 engages the first clutch 331, the second clutch 332, and the third clutch 333 to transmit the power of the motor 310 to the low pressure section 221, the medium-low pressure section 222, the medium-high pressure section 223, and the high pressure section 224 of the compressor module 220, i.e., the entire compressor module 220, thereby driving the entire compressor module 220.

Further, the controller 400 opens the high pressure section valve 244 and closes the remaining valves 240 so that air flowing in through the inlet of the casing 210 passes through the low pressure section 221, the medium-low pressure section 222, the medium-high pressure section 223, the high pressure section 224, and the chamber 230 and is discharged to the high pressure section exhaust line 144 (see FIG. 7).

While one or more exemplary embodiments have been described with reference to the accompanying drawings, it will be apparent to those skilled in the art that various modifications and variations can be made through addition, change, omission, or substitution of components without departing from the spirit and scope of the disclosure described in the appended claims, and these modifications and changes fall within the spirit and scope of the disclosure as defined in the appended claims.

What is claimed is:

1. A load absorption apparatus for gas turbine testing, the apparatus comprising:
a load compressor placed in front of a gas turbine and having a plurality of compressor modules arranged in sections according to a capacity of the gas turbine; and
a drive module configured to provide power to the load compressor.

2. The apparatus of claim 1, wherein the load compressor is an axial-type multi-stage compressor, and the compressor module is sequentially divided according to the capacity of the gas turbine.

3. The apparatus of claim 1, further comprising:
a controller configured to selectively drive the load compressor or the drive module based on a preset capacity of the gas turbine.

4. The apparatus of claim 1, wherein the load compressor comprises:
a casing in which an inlet is formed at a front end to allow air to flow in and the compressor modules are sequentially arranged inside;
a chamber installed at a rear end of the casing and configured to communicate with the casing;
a plurality of exhaust lines installed in the casing and the chamber; and
a plurality of valves installed on each exhaust line to open and close the exhaust line.

5. The apparatus of claim 4, wherein the compressor modules are divided according to the capacity of the gas turbine along an air flow direction from the front end of the casing and comprise a low pressure section, a medium-low pressure section, a medium-high pressure section, and a high pressure section,

6. The apparatus of claim 5, wherein
the low pressure section is positioned at the front end of the casing and is configured to communicate with the inlet of the casing;
the medium-low pressure section is positioned at a rear end of the low pressure section and is configured to communicate with the low pressure section;
the medium-high pressure section is positioned at a rear end of the medium-low pressure section and is configured to communicate with the medium-low pressure section; and
the high pressure section is positioned at a rear end of the medium-high pressure section and is configured to communicate with the medium-high pressure section.

7. The apparatus of claim 6, wherein the exhaust lines comprise:
a low pressure section exhaust line positioned between the low pressure section and the medium-low pressure section and configured to communicate with the casing;
a medium-low pressure section exhaust line positioned between the medium-low pressure section and the medium-high pressure section and configured to communicate with the casing;
a medium-high pressure section exhaust line positioned between the medium-high pressure section and the high pressure section and configured to communicate with the casing; and
a high pressure section exhaust line configured to communicate with the chamber.

8. The apparatus of claim 7, wherein the valve is a discharge valve configured to be controlled remotely.

9. The apparatus of claim 7, wherein the valves comprise:
a low pressure section valve installed in the low pressure section exhaust line to open and close the low pressure section exhaust line;
a medium-low pressure section valve installed in the medium-low pressure section exhaust line to open and close the medium-low pressure section exhaust line;
a medium-high pressure section valve installed in the medium-high pressure section exhaust line to open and close the medium-high pressure section exhaust line; and
a high pressure section valve installed in the high pressure section exhaust line to open and close the high pressure section exhaust line.

10. The apparatus of claim 9, wherein the chamber and the valves are configured to control back pressure and load.

11. The apparatus of claim 6, wherein the drive module comprises:
a motor;
a rotary shaft installed on the motor and configured to rotate; and
a clutch including a plurality of clutches and installed between the rotary shaft and the compressor modules, the clutches being spaced apart from each other along a length direction of the rotary shaft to selectively transmit power of the motor to the compressor modules.

12. The apparatus of claim 11, wherein the clutches comprise:
a first clutch installed on the rotary shaft and positioned between the low pressure section and the medium-low pressure section;
a second clutch installed on the rotary shaft and positioned between the medium-low pressure section and the medium-high pressure section; and
a third clutch installed on the rotary shaft and positioned between the medium-high pressure section and the high pressure section.

13. A load absorption method for gas turbine testing using a load absorption apparatus, the method comprising:
selecting a compressor module according to a capacity of the gas turbine; and
transmitting power to the compressor module.

14. The method of claim 13, wherein in the selecting of compressor module, the capacity of the gas turbine to be tested is preset in the controller, and the compressor module corresponding to the capacity of the gas turbine is selected from among a plurality of compressor modules based on the preset gas turbine capacity.

15. The method of claim 13, wherein in the transmitting of power, when the low pressure section is selected, the first clutch is disengaged to transmit the power of the motor to the low pressure section of the compressor modules to drive the low pressure section.

16. The method of claim 15, wherein when the low pressure section is selected, the low pressure section valve opens and the other valves close, so that air flowing in through the inlet of the casing passes through the low pressure section and is discharged to the low pressure section exhaust line.

17. The method of claim 13, wherein in the transmitting of power, when the medium-low pressure section is selected, the first clutch is engaged and the second clutch is disengaged to transmit the power of the motor to the low pressure section and the medium-low pressure section of the compressor modules, thereby driving the low pressure section and the medium-low pressure section.

18. The method of claim 13, wherein in the transmitting of power, when the medium-high pressure section is selected, the first clutch and the second clutch are engaged and the third clutch is disengaged to transmit the power of the motor to the low pressure section, the medium-low pressure section, and the medium-high pressure section of the compressor modules, so that the low pressure section, the medium-low pressure section, and the medium-high pressure section are driven.

19. The method of claim 13, wherein in the transmitting of power, when the high pressure section is selected, the first clutch, the second clutch, and the third clutch are engaged to transmit the power of the motor to the low pressure section, the medium-low pressure section, the medium-high pressure section, and the high pressure section of the compressor modules, so that the entire plurality of compressor modules is driven.

20. The method of claim 19, wherein when the high pressure section is selected, the high pressure section valve opens and the other valves close, so that air flowing in through the inlet of the casing passes through the low pressure section, the medium-low pressure section, the medium-high pressure section, the high pressure section, and the chamber, and is discharged to the high pressure section exhaust line.
